(19) United States
(12) Patent Application Publication
(10) Pub. No.: US 2012/0217200 A1
(43) Pub. Date: Aug. 30, 2012

(54) ONE-WAY FILTER DRIER

(75) Inventor: Linping Wu, Zhejiang (CN)

(73) Assignee: Zhejiang Sanhua Climate and Appliance Controls Group Co., Ltd, Zhejiang (CN)

(21) Appl. No.: 13/405,510

(22) Filed: Feb. 27, 2012

(30) Foreign Application Priority Data
Feb. 28, 2011 (CN) 201110048346.5

(51) Int. Cl. B01D 27/14

(52) U.S. Cl. 210/352

(57) ABSTRACT

Disclosed herein is a one-way filter drier comprising a cartridge having an inlet and an outlet, a molecular sieve being provided inside the cartridge, a first filter sheet being provided between the molecular sieve and the outlet, a spring and a second filter sheet being provided between the inlet and the molecular sieve in sequence, wherein at least one piece of third filter sheet is provided in the spring. In the one-way filter drier provided by the present application, the third filter sheet is provided in the spring, the refrigerant still has relative large flowing space after entering via the inlet, which may ensure the requirement of the fluid flux; at the same time, the third filter sheet combining with the first filter sheet and the second filter sheet may maximize the filter capacity.

The present application claims the benefit of priority to Chinese patent application No. 201110048346.5 titled “ONE-WAY FILTER DRIER”, filed with the Chinese State Intellectual Property Office on Feb. 28, 2011. The entire disclosure thereof is incorporated herein by reference.

### FIELD OF THE INVENTION

This application relates to the technical field of filters, in particular to a one-way filter drier.

### BACKGROUND OF THE INVENTION

In the operation of a refrigerating device, throttling components are easy to be blocked by impurities such as solid powder and dirt produced from refrigerant and refrigeration oil. In addition, trace moisture contained in the refrigerant will cause great damage to the refrigerating system, thus the refrigerant or the refrigeration oil needs to be dried and filtered.

A one-way filter drier is generally installed between a condenser and an expansion valve, and is mainly applicable to a one-way flowing refrigeration pipe line. Components for drying and filtering are provided inside the one-way filter drier to dry and filter the refrigerant, so as to effectively prevent filtered substances or soluble substances from entering into critical components of the refrigerating system, which ensures that the system may operate in the optimum state.

The filter capacity and fluid flux are performance indexes of the one-way filter drier. The filter capacity is a critical index, and is represented by the ratio of the impurities locked in the one-way filter drier under a certain pressure drop to the whole impurities with known quantity and specified mesh number and size which are put into the one-way filter drier. If the impurity ratio is one hundred percent, all impurities may be filtered and the highest filter capacity is achieved. The fluid flux refers to the weight of the refrigerant passing through the one-way filter drier under a certain pressure drop. The greater the fluid flux is, the better the performance is.

Referring to FIG. 1, a schematic view of the structure of a conventional one-way filter drier is shown.

The one-way filter drier in the prior art generally has a cartridge 26, and an inlet cover 20 and an outlet cover 30 are located at two ends thereof and communicate with an inlet pipe and an outlet pipe respectively. An inlet blocking net 21, a spring 22, an intermediate filter sheet 23, an intermediate blocking net 24, a molecular sieve 25, an outlet filter sheet 27, a sieving net 28 and an outlet blocking net 29 are provided in sequence between the inlet cover 20 and the outlet cover 30. In assembling, the molecular sieve 25, the outlet filter sheet 27, the to sieving net 28 and the outlet blocking net 29 are pressed tightly in sequence at the outlet cover 30. Two ends of the spring 22 abuts against the intermediate filter sheet 23 and the inlet blocking net 21 respectively so as to force the intermediate blocking net 24 and the intermediate filter sheet 23 towards the molecular sieve 25, thereby playing a role of positioning. The molecular sieve 25 has drying function, and the filter sheets are of glass fiber net structure and have filtering function. After entering into the one-way filter drier via the inlet, the refrigerant is filtered and dried, and then flows out via the outlet.

The one-way filter drier of the above structure is only provided with the intermediate filter sheet 23 and the outlet filter sheet 27 to satisfy the requirement of the fluid flux in a certain degree, but has limited impurity filter capacity.

Therefore, the technical problem to be solved by the person skilled in the art is to provide a one-way filter drier having best filter capacity while satisfying the requirement of the fluid flux.

### SUMMARY OF THE INVENTION

The object of the present application is to provide a one-way filter drier having best filter capacity while satisfying the requirement of the fluid flux.

For solving the above technical problems, the present application provides a one-way filter drier including a cartridge having an inlet and an outlet, a molecular sieve being provided inside the cartridge, a first filter sheet being provided between the molecular sieve and the outlet, a spring and a second filter sheet being provided between the inlet and the molecular sieve in sequence, and at least one piece of the third filter sheet being provided in the spring.

Preferably, the third filter sheet is fastened by the spring.

Preferably, a diameter of one end of the spring contacting with an inlet blocking net is less than a diameter of the inlet blocking net.

Preferably, a diameter of a bottom portion of the spring abutting against the second filter sheet is equal to a diameter of the second filter sheet.

Preferably, the second filter sheet is made of glass wool board and the first filter sheet is made of glass wool felt.

Preferably, the glass wool board has a density ρ₂ meeting an expression of 25 kg/m³≦ρ₂≦50 kg/m³, a thickness t₂ meeting an expression of 10 mm≦t₂≦50 mm, and a fiber diameter d₂ not larger than 10 μm; and the glass wool felt has a density ρ₁ meeting an expression of 10 kg/m³≦ρ₁≦40 kg/m³, a thickness t₁ meeting an expression of 20 mm≦t₁≦30 mm, and a fiber diameter d₁ not larger than 15 μm.

Preferably, the third filter sheet is made of glass wool board with a density ρ₃ meeting an expression of 25 kg/m³≦ρ₃≦50 kg/m³, a thickness t₃ meeting an expression of 10 mm≦t₃≦50 mm and a fiber diameter d₃ not larger than 10 μm.

In the one-way filter drier provided by the present application, the third filter sheet is provided in the spring, the refrigerant still has relative large flowing space after entering via the inlet, which may ensure the requirement of the fluid flux; at the same time, the third filter sheet combining with the first filter sheet and the second filter sheet may maximize the filter capacity.

### BRIEF DESCRIPTION OF THE DRAWINGS

FIG. 1 is a schematic view of the structure of a conventional one-way filter drier;

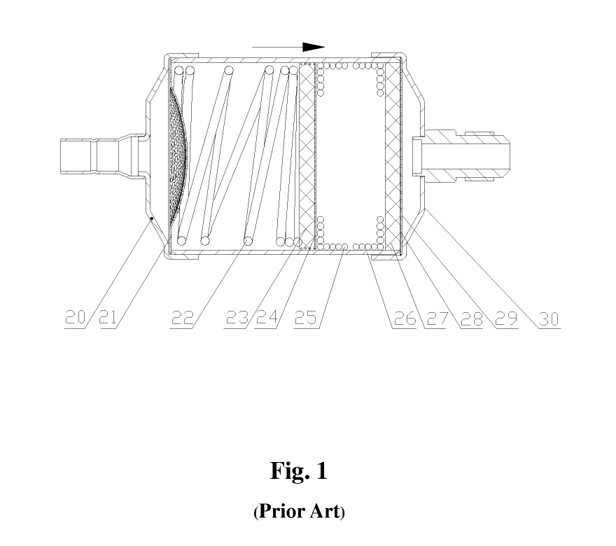

FIG. 2 is a schematic view of the structure of a one-way filter drier according to an embodiment of the present application; and

FIG. 3 is a schematic view of the one-way filter drier shown in FIG. 2, illustrating the flowing direction of the refrigerant therein.

### DETAILED DESCRIPTION OF THE EMBODIMENTS

The object of the present application is to provide a one-way filter drier having best filter capacity while satisfying the requirement of the fluid flux.

For the person skilled in the art to better understand the technical solution of the present application, the present application will be described in detail in conjunction with drawings and embodiments hereinafter.

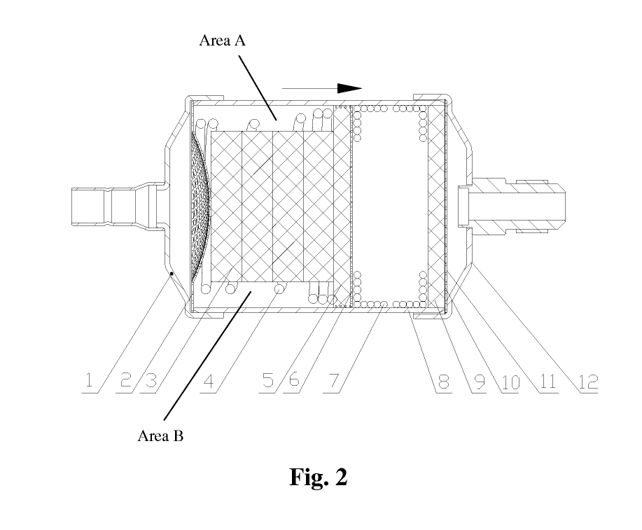

Referring to FIG. 2, a schematic view of the structure of a one-way filter drier according to an embodiment of the present application is shown.

The one-way filter drier provided by the present application includes a cartridge 8. The cartridge 8 has an inlet and an outlet connecting to an inlet pipe and an outlet pipe for the refrigerant respectively and sealed by an inlet cover 1 and an outlet cover 12 respectively. A molecular sieve 7 is provided inside the cartridge 8 to perform a drying function, and is located at the outlet. Only a part of the molecular sieve 7 is shown in FIG. 2. A first filter sheet 9 is provided between the molecular sieve 7 and the outlet. A sieve net 10 and an outlet blocking net 11 may be further provided between the first filter sheet 9 and the outlet to perform a further filter function. A spring 4 and a second filter sheet 5 are provided between the inlet and the molecular sieve 7 in sequence. One end of the spring 4 abuts against an inlet blocking net 2 at the inlet, and the other end thereof pushes the second filter sheet 5 against one side of the molecular sieve 7, that is, the second filter sheet 5 is located at one side of the molecular sieve 7 by the spring 4. An intermediate blocking net 6 may be further provided between the second filter sheet 5 and the molecular sieve 7.

In addition, at least one piece of a third filter sheet 3 is provided in the spring 4, being coaxial with the spring 4. The number of the third filter sheet 3 may be determined based on a real designed length of the filter drier and the required amount of filtered impurities.

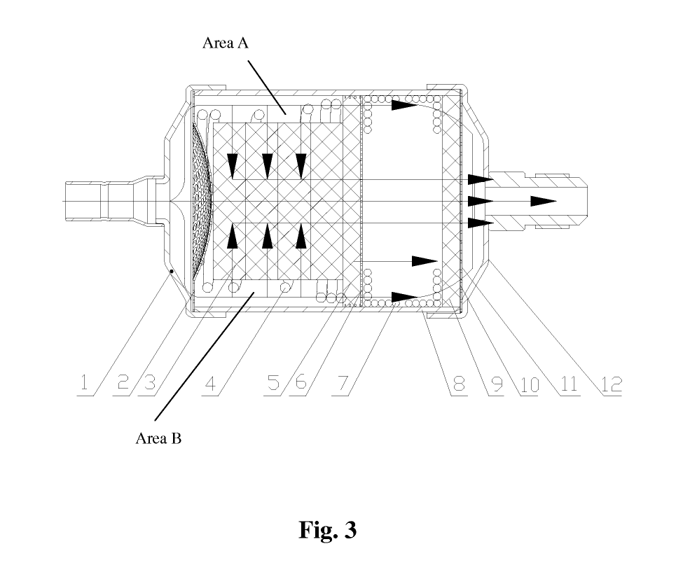

Referring to FIG. 3, a schematic view of the one-way filter drier shown in FIG. 2 is shown, illustrating the flowing direction of the refrigerant therein.

When the refrigerant flows into the one-way filter drier of the above structure via the inlet, at an initial stage, the refrigerant mostly flows to the second filter sheet 5 through the periphery of the inlet blocking net 2 due to the third filter sheet 3 provided in the spring 4, and then filtered by the second filter sheet 5. Thus, filtered impurities are mostly distributed in an area between the periphery of the third filter sheet 3 and an inner wall of the cartridge 8, and are mostly gathered in an area close to the second filter sheet 5. After operating a period of time, a continuous and stable stage of locking the impurities is entered, i.e., the peak period of the one-way filter drier for filtering the impurities. At this time, a certain amount of impurities are stored in the area between the periphery of the third filter sheet 3 and the inner wall of the cartridge 8 and close to the second filter sheet 5, thus the refrigerant flowing to the periphery of the cartridge 8 mostly flows in through the outer side of the third filter sheet 3 in the spring 4, and then flows to the second filter sheet 5 after filtered by the third filter sheet 3. Glass fiber of the third filter sheet 3 may lock the impurities inside the third filter sheet 3 and the area between the periphery of the third filter sheet 3 and the inner wall of the cartridge 8. After a certain amount of the impurities is accumulated in the area between the periphery of the third filter sheet 3 and the inner wall of the cartridge 8, the refrigerant may flow along the straight line directly after entering via the inlet, and passes through the third filter sheet 3 and the second filter sheet 5 in sequence, and then flows out via the outlet.

In the one-way filter drier of the above structure, the filter sheet(s) is provided in the spring 4. In this way, after entering via the inlet, the refrigerant still has relatively large flowing space, which may ensure the requirement of the fluid flux; at the same time, the third filter sheet 3 combining with the first filter sheet 9 and the second filter sheet 5 may maximize the filter capacity.

Referring to table 1, it shows experimental data of the filter capacity and the fluid flux of the one-way filter drier with the third filter sheet 3 being provided in the spring and of the one-way filter drier without the third filter sheet 3.

TABLE 1

| | | Percentage of the |
|---|---|---|
| Experimental conditions | Fluid flux | filtered impurities |
| There is no filter sheet in the spring, the | A | 21% |
| first filter sheet and the second filter sheet | | |
| employ glass wool felt | | |
| A third filter sheet is provided in the | 0.865a | 45% |
| spring, the first filter sheet and the second | | |
| filter sheet employ glass wool felt | | |

As can be seen from table 1, the one-way filter drier provided with the third filter sheet 3 has a fluid flux still satisfying the basic requirement and a greatly improved filter capacity.

The third filter sheet 3 needs to be secured in the spring 4. The third filter sheet 3 may be fastened by the spring 4. For example, the third filter sheet 3 may have a circular cross section with the diameter slightly greater than or equal to the diameter of the portion of the spring 4 where the third filter sheet 3 is disposed. In this way, the third filter sheet 3 may be positioned after being pressed and fit into the spring 4. This is a simple and easy way to carry out.

The diameter of the end portion of the spring 4 contacting with the inlet blocking net 2 may be less than the diameter of the inlet blocking net 2. The inlet blocking net 2 generally protrudes toward the inside of the cartridge 8, and the protruded end portion thereof extends into the inside of the spring 4 so as to better position the spring 4. By providing the diameter of the end portion of the spring 4 less than the diameter of the inlet blocking net 2, i.e., as shown in FIG. 2 the diameter of the left end of the spring 4 slightly less than the diameter of the inlet blocking net 2, the inlet blocking net 2 may position the spring 4 more stably in assembling. Thus, the installation is convenient.

The diameter of the bottom portion of the spring 4 abutting against the second filter sheet 5 may be equal to the diameter of the second filter sheet 5 so as to position the second filter sheet 5 at one side of the molecular sieve 7 and to prevent the second filter sheet 5 from turning over. Certainly, the diameter of the bottom portion of the spring 4 that is approximately equal to the diameter of the second filter sheet 5 may also realize the above object.

The second filter sheet 5 may be made of glass wool board, and the first filter sheet 9 may be made of glass wool felt. Glass wool board is a sheet material product with a certain strength made from centrifugal glass wool through the solidification process. Glass wool board has relatively dense glass fiber net structure, thus has high filter capacity and may also satisfy the requirement of fluid flux. Glass wool felt is formed by adding thermosetting adhesive into glass fibers and then heating, solidifying and shaping the resultant matter. Compared with glass wool board, glass wool felt has sparser glass fiber net structure, thus has a lower filter capacity, to but may satisfy higher requirement of fluid flux.

In the whole cartridge 8, the area between the inner wall of the cartridge 8 and the third filter sheet 3 and close to the second filter sheet 5 is a main area for locking the impurities, thus the second filter sheet 5 plays a main role in the filter process of the whole one-way filter drier. Under the condition that the fluid flux is ensured, it is better for the second filter sheet 5 to have smaller density of glass fibers so as to filter most of the impurities in the main area. The rest small part of the impurities may be fully filtered when passing through the first filter sheet 9. Therefore, the second filter sheet 5 is made of glass wool board material. The first filter sheet 9 is located at the outlet of the refrigerant, thus is made of flexible glass wool felt material for ensuring the fluid flux so as to re-filter the refrigerant filtered by the second filter sheet 5 while fully satisfying the requirement of fluid flux.

Referring to table 2, it shows experimental data of the filter capacity and the fluid flux of the one-way filter drier, in which the third filter sheet is provided in the spring, and the first filter sheet and the second filter sheet are made of glass wool felt and glass wool board respectively or both are made of glass wool felt.

TABLE 2

| | | Percentage of the |
|---|---|---|
| Experimental conditions | Fluid flux | filtered impurities |
| A third filter sheet is provided in the | b | 45% |
| spring, the first filter sheet and the | | |
| second filter sheet both are made of | | |
| glass wool felt | | |
| A third filter sheet is provided in the | 0.91b | 65% |
| spring, the first filter sheet is made of | | |
| glass wool felt and the second filter | | |
| sheet is made of glass wool board | | |

As can be seen from table 2, in the case that the first filter sheet 9 is made of glass wool felt and the second filter sheet 5 is made of glass wool board, the change of the fluid flux is relatively small, but the filter capacity is greatly improved.

Further, the glass wool board of the second filter sheet 5 may have the density ρ₂ meeting the expression of 25 kg/m³≦ρ₂≦50 kg/m³, the thickness t₂ meeting the expression of 10 mm≦t₂≦50 mm, and the fiber diameter d₂ not larger than 10 μm. The glass wool felt of the first filter sheet 9 may have the density ρ₁ meeting the expression of 10 kg/m³≦ρ₁≦40 kg/m³, the thickness t₁ meeting the expression of 20 mm≦t₁≦30 mm, and the fiber diameter d₁ not to larger than 15 μm. With the above parameter limitations, the first filter sheet 9 and the second filter sheet 5 provide the one-way filter drier with a great filter performance while satisfying the requirement of fluid flux.

Referring to table 3, it shows experimental data of the filter capacity and the fluid flux of the one-way filter drier with different parameters by the same experimental method as table 2, in which the second filter sheet 5 is made of glass wool board and the first filter sheet 9 is made of glass wool felt.

TABLE 3

| | | Percentage of |
|---|---|---|
| | Fluid | the filtered |
| Experimental conditions | flux | impurities |
| The second filter sheet: ρ2 = 25 kg/m3, | b | 63% |
| t2 = 10 mm, d2 = 10 μm; The first filter | | |
| sheet: ρ1 = 10 kg/m3, t1 = 20 mm, | | |
| d1 = 15 μm | | |
| The second filter sheet: ρ2 = 35 kg/m3, | 0.986b | 65% |
| t2 = 30 mm, d2 = 5 μm; The first filter | | |
| sheet: ρ1 = 30 kg/m3, t1 = 25 mm, | | |
| d1 = 10 μm | | |
| The second filter sheet: ρ2 = 50 kg/m3, | 0.972b | 68% |
| t2 = 50 mm, d2 = 2 μm; The first filter | | |
| sheet: ρ1 = 40 kg/m3, t1 = 30 mm, | | |
| d1 = 5 μm | | |
| The second filter sheet: ρ2 = 15 kg/m3, | 1.04b | 60% |
| t2 = 5 mm, d2 = 15 μm; The first filter | | |
| sheet: ρ1 = 5 kg/m3, t1 = 10 mm, | | |
| d1 = 20 μm | | |

The third filter sheet 3 is provided in the spring 4 and is located at the inlet. In an intermediate filter stage, most of the refrigerant enters into the one-way filter drier through the outer side of the third filter sheet 3, and the impurities are filtered in areas A and B. In a last filter stage, the refrigerant also flows through the third filter sheet 3. Thus, the third filter sheet 3 also is made of glass wool board with denser glass fibers, which is the similar material as the second filter sheet 5, to improve the filter capacity. The glass wool board of the third filter sheet 3 may have the density ρ₃ meeting the expression of 25 kg/m³≦ρ₃≦50 kg/m³, the thickness t₃ meeting the expression of 10 mm≦t₃≦50 mm, and the fiber diameter d₃ not larger than 10 μm.

Referring to table 4, it shows experimental data of the filter capacity and the fluid flux of the one-way filter drier with different parameters by the same experimental method as table 2, in which the third filter sheet 3 is made of glass wool board, the first filter sheet 9 and the second filter sheet 5 are made of glass wool felt and glass wool board respectively.

TABLE 4

| | | Percentage of |
|---|---|---|
| | Fluid | the filtered |
| Experimental conditions | flux | impurities |
| The third filter sheet: ρ₃ = 25 kg/m³, | c | 66% |
| t₃ = 10 mm, d₃ = 10 μm | | |
| The third filter sheet: ρ₃ = 35 kg/m³, | 0.986c | 67% |
| t₃ = 30 mm, d₃ = 5 μm | | |
| The third filter sheet: ρ₃ = 50 kg/m³, | 0.978c | 69% |
| t₃ = 50 mm, d₃ = 2 μm | | |
| The third filter sheet: ρ₃ = 15 kg/m³, | 1.02c | 62% |
| t₃ = 5 mm, d₃ = 15 μm | | |

The one-way filter drier provided by the present application is described in detail hereinbefore. The principle and the embodiments of the present application are illustrated by specific examples. The description of examples is only intended to help the understanding of the method and the spirit of the present application. It should be noted that, for the person skilled in the art, many modifications and improvements may be made to the present application without departing from the principle of the present application, and these modifications and improvements are also deemed to fall into the protection scope of the present application defined by the claims.

What is claimed is:

1. A one-way filter drier, comprising a cartridge having an inlet and an outlet, a molecular sieve being provided inside the cartridge, a first filter sheet being provided between the molecular sieve and the outlet, a spring and a second filter sheet being provided between the inlet and the molecular sieve in sequence, wherein at least one piece of third filter sheet is provided in the spring.

2. The one-way filter drier according to claim 1, wherein the third filter sheet is fastened by the spring.

3. The one-way filter drier according to claim 2, wherein a diameter of one end of the spring contacting with an inlet blocking net is less than a diameter of the inlet blocking net.

4. The one-way filter drier according to claim 3, wherein a diameter of a bottom portion of the spring abutting against the second filter sheet is equal to a diameter of the second filter sheet.

5. The one-way filter drier according to claim 1, wherein the second filter sheet is made of glass wool board and the first filter sheet is made of glass wool felt.

6. The one-way filter drier according to claim 5, wherein the glass wool board has a density ρ₂ meeting an expression of 25 kg/m³≦ρ₂≦50 kg/m³, a thickness t₂ meeting an expression of 10 mm≦t₂≦50 mm, and a fiber diameter d₂ not larger than 10 μm; and the glass wool felt has a density ρ₁ meeting an expression of 10 kg/m³≦ρ₁≦40 kg/m³, a thickness t₁ meeting an expression of 20 mm≦t₁≦30 mm, and a fiber diameter d₁ not larger than 15 μm.

7. The one-way filter drier according to claim 6, wherein the third filter sheet is made of glass wool board with a density ρ₃ meeting an expression of 25 kg/m³≦ρ₃≦50 kg/m³, a thickness t₃ meeting an expression of 10 mm≦t₃≦50 mm and a fiber diameter d₃ not larger than 10 μm.
